(19) United States
(12) Patent Application Publication
(10) Pub. No.: US 2026/0205680 A1
(43) Pub. Date: Jul. 16, 2026

(54) CAMERA CONTROL SYSTEM AND METHOD USING SCHEDULER

(71) Applicant: HANWHA VISION CO., LTD., Seongnam-si (KR)

(72) Inventor: Raman SUJITH, Seongnam-si (KR)

(73) Assignee: HANWHA VISION CO., LTD., Seongnam-si (KR)

(21) Appl. No.: 19/134,572

(22) PCT Filed: Sep. 18, 2023
(86) PCT No.: PCT/KR2023/014007

§ 371 Date: May 30, 2025

(30) Foreign Application Priority Data
Dec. 1, 2022 (KR) 10-2022-0165965

(51) Int. Cl. H04N 23/617

(52) U.S. Cl. CPC H04N 23/617

(57) ABSTRACT

The present disclosure provides a system for controlling a camera, the system including a processor configured to control an application installed in a camera, and a memory storing instructions executable by the processor, wherein the processor includes an app manager module configured to monitor the application and control an operation of the application, and a scheduler setting module configured to provide, to the app manager module, information about a scheduler that is mapped to the application and includes information about the operation of the application at a preset time.

### TECHNICAL FIELD

Embodiments of the present disclosure relate to a system and method for controlling a camera by using a scheduler.

### BACKGROUND ART

IP cameras tend to expand their functions by installing additional application programs or applications on the cameras, and these applications can only be stopped manually or through external intervention, such as an external application program that stops the applications, once the operations of the applications start.

In the existing camera control system, functions related to an application installed on a camera allows the installation, start, stop, and removal of the application, and it is difficult for a user to operate the application only at a certain time or on a certain day of the week.

### DISCLOSURE OF INVENTION

### Technical Problem

The present disclosure is intended to solve various problems including the above problems, and aims to provide a system and method for controlling a camera by using a scheduler. However, these tasks are examples, and the scope of the present disclosure is not limited thereby.

### Solution to Problem

According to an aspect of the present disclosure, there is provided a system for controlling a camera, the system including a processor configured to control an application installed in a camera, and a memory storing instructions executable by the processor, wherein the processor includes an app manager module configured to monitor the application and control an operation of the application, and a scheduler setting module configured to provide, to the app manager module, information about a scheduler that is mapped to the application and includes information about the operation of the application at a preset time.

The app manager module may be further configured to activate or deactivate the application based on the information about the operation of the application received from the scheduler setting module.

The app manager module may be further configured to check a scheduler mapped to the application and activate the application only at a preset time based on information about the scheduler mapped to the application.

The scheduler setting module may be further configured to provide information about a plurality of schedulers mapped to a plurality of applications to the app manager module.

The scheduler setting module may be further configured to reset information about the mapping between the application and the scheduler.

The scheduler setting module may be further configured to update the information about the scheduler including the information about the operation of the application based on update information about settings of the scheduler.

The app manager module may be further configured to update the information about the scheduler, which is mapped to the application and includes the information about the operation of the application at a preset time, according to update of the scheduler setting module.

According to an aspect of the present disclosure, there is provided a method of controlling a camera by using a processor that controls an application installed in the camera, the method including monitoring the application, and controlling an operation of the application based on information about a scheduler that is mapped to the application and includes information about the operation of the application at a preset time.

The controlling of the operation of the application may include activating or deactivating the application based on the information about the operation of the application.

The controlling of the operation of the application may include checking a scheduler mapped to the application, and activating the application only at a preset time based on information about the scheduler mapped to the application.

The controlling of the operation of the application may include controlling the operation of the application based on information about a plurality of schedulers mapped to a plurality of applications.

The controlling of the operation of the application may include resetting information about the mapping between the application and the scheduler.

The controlling of the operation of the application may include updating the information about the scheduler including the information about the operation of the application based on update information about settings of the scheduler.

The controlling of the operation of the application may include updating the information about the scheduler that is mapped to the application and includes the information about the operation of the application at a preset time.

According to an aspect of the present disclosure, there is provided a computer program stored in a recording medium to execute the method by using a computing device.

Other aspects, features, and advantages of the present disclosure will become more apparent from the detailed description, the claims, and the drawings.

### Advantageous Effects of Invention

According to an embodiment of the present disclosure as described above, a camera control system and method capable of effectively controlling an application installed in a camera by using a scheduler may be implemented. However, the scope of the present disclosure is not limited by this effect.

### BRIEF DESCRIPTION OF DRAWINGS

FIG. 1 is a diagram for explaining a configuration and operation of a camera control system according to an embodiment of the present disclosure.

FIG. 2 and FIG. 3 are diagrams for explaining a configuration and operation of a processor included in a camera control system according to an embodiment of the present disclosure.

FIG. 4 is a diagram for explaining an application and a scheduler mapped to the application, according to an embodiment of the present disclosure.

FIGS. 5 and 6 are flowcharts illustrating a camera control method according to an embodiment of the present disclosure.

### BEST MODE FOR CARRYING OUT THE INVENTION

As the present disclosure allows for various changes and numerous embodiments, certain embodiments will be illustrated in the drawings and described in the detailed description. Effects and features of the present disclosure, and methods for achieving them will be clarified with reference to embodiments described below in detail with reference to the drawings. However, the present disclosure is not limited to the following embodiments and may be embodied in various forms.

Hereinafter, embodiments of the present disclosure will be described in detail with reference to the accompanying drawings, wherein the same or corresponding elements are denoted by the same reference numerals throughout and a repeated description thereof is omitted.

Although the terms “first,” “second,” etc. may be used to describe various elements, these elements should not be limited by these terms. These terms are only used to distinguish one element from another. The singular forms “a,” “an,” and “the” are intended to include the plural forms as well, unless the context clearly indicates otherwise. It will be further understood that the terms “includes” or “has” used herein specify the presence of stated features or components, but do not preclude the presence or addition of one or more other features or components.

Sizes of components in the drawings may be exaggerated or reduced for convenience of explanation. For example, because sizes and thicknesses of components in the drawings are arbitrarily illustrated for convenience of explanation, the present disclosure is not limited thereto.

It will be further understood that, when a region, component, unit, block, or module is referred to as being “on” another region, component, unit, block, or module, it may be directly on the other region, component, unit, block, or module or may be indirectly on the other region, component, unit, block, or module with intervening regions, components, units, blocks, or modules therebetween. It will be further understood that, when a region, component, unit, block, or module is referred to as being connected to another region, component, unit, block, or module, it may be directly connected to the other region, component, unit, block, or module or may be indirectly connected to the other region, component, unit, block, or module with intervening regions, components, units, blocks, or modules therebetween.

Various embodiments of the present disclosure will now be described more fully with reference to the accompanying drawings for one of ordinary skill in the art to be able to perform the present disclosure without any difficulty.

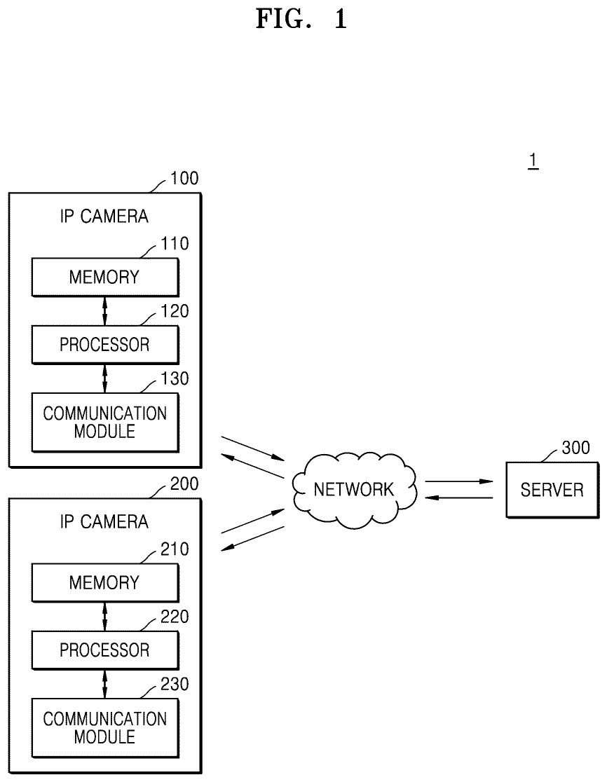

FIG. 1 is a diagram for explaining a configuration and operation of a system for controlling a camera (hereinafter, referred to as a camera control system), according to an embodiment of the present disclosure.

Referring to FIG. 1, a camera control system 1 according to an embodiment of the present disclosure may include cameras 100 and 200 and a server 300. However, the present disclosure is not limited thereto, and the camera control system 1 may further include other elements or some elements may be omitted. Some elements of the camera control system 1 may be separated into a plurality of devices, or a plurality of elements may be combined into one device. For example, although a first IP camera 100 and a second IP camera 200 are illustrated in FIG. 1, the camera control system 1 may include one camera or two or more cameras.

The server 300 may be a server device for controlling an operation of the camera control system 1. For example, the server 300 may be connected to the cameras 100 and 200 through a network to transmit and receive data with the cameras 100 and 200.

The camera 100 according to an embodiment of the present disclosure may include a memory 110, a processor 120, and a communication module 130. Hereinafter, the memory 110, the processor 120, and the communication module 130, which are elements of the first IP camera 100, will be described, but the description may apply to elements of the second IP camera 200.

The communication module 130 may provide a function for communicating with an external device through the network. For example, a request generated by the processor 120 of the camera 100 according to program code stored in a recording device such as the memory 110 may be transmitted to the external device through the network under the control by the communication module 130. Conversely, a control signal, a command, content, or a file provided from the external device may be received by the camera 100 through the network and through the communication module 130. For example, a control signal or a command of the external device received through the communication module 130 may be transmitted to the processor 120 or the memory 110.

A communication method is not limited, and may include not only a communication method using a communication network (e.g., a mobile communication network, wired Internet, wireless Internet, or a broadcasting network) that may be included in the network, but also short-range wireless communication between devices. For example, the network may include at least one of a personal area network (PAN), a local area network (LAN), a campus area network (CAN), a metropolitan area network (MAN), a wide area network (WAN), a broadband network (BBN), and the Internet. Also, the network may include at least one of network topologies including, but not limited to, a bus network, a star network, a ring network, a mesh network, a star-bus network, and a tree or hierarchical network.

Also, the communication module 130 may communicate with an external server through the network. A communication method is not limited, but the network may be a short-range wireless communication network. For example, the network may be Bluetooth, Bluetooth low energy (BLE), or Wi-Fi communication network.

Also, the camera 100 according to the present disclosure may include a user interface module. The user interface module may be a means for interfacing with an input/output device. For example, the input device may include a device such as a keyboard or a mouse, and the output device may include a device such as a display for displaying a communication session of an application. In another example, the user interface module may be a means for interfacing with a device in which input and output functions are integrated into one such as a touchscreen. In a more detailed example, when the processor 120 of the camera 100 processes a command of a computer program loaded into the memory 110, a service screen or content configured by using data provided by the external device may be displayed on the display through the user interface module.

The memory 110 is a computer-readable recording medium, and may include random-access memory (RAM), read-only memory (ROM), or a permanent mass storage device such as a disk drive. Also, program code for controlling the camera may be temporarily or permanently stored in the memory 110.

The processor 120 may control an application installed in the camera 100. For example, the application may be stored in the memory 110. In addition, the processor 120 may monitor the application. In addition, the processor 120 may control the operation of the application based on information about a scheduler that is mapped to the application and includes information about the operation of the application at a preset time. For example, the scheduler may be stored in the memory 110.

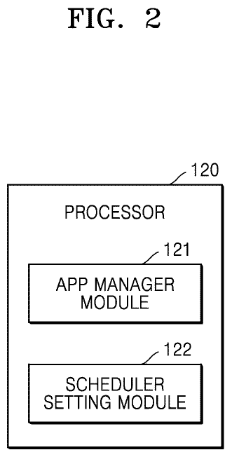

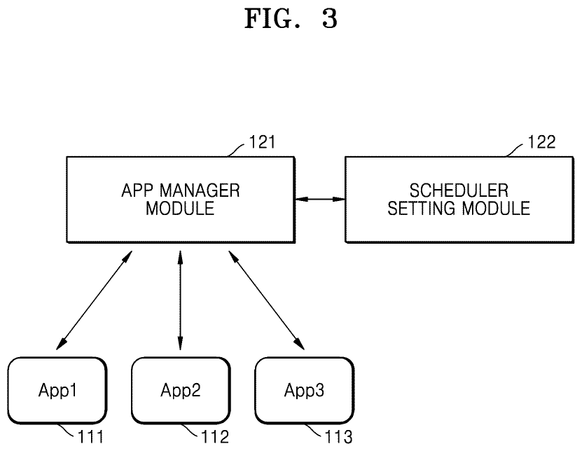

FIG. 2 and FIG. 3 are diagrams for explaining a configuration and operation of a processor included in a camera control system according to an embodiment of the present disclosure.

Referring to FIG. 2, a processor 120 according to an embodiment of the present disclosure may include an app manager module 121 and a scheduler setting module 122. According to some embodiments, elements of the processor 120 may be selectively included in or excluded from the processor 120. Also, according to some embodiments, elements of the processor 120 may be separated or combined to express functions of the processor 120.

The processor 120 and elements of the processor 120 may be implemented to execute instructions according to code of an operating system and code of at least one program, included in the memory 110. Elements of the processor 120 may represent different functions of the processor 120 performed by the processor 120 according to a command provided by the program code stored in the memory 110. An internal configuration and detailed operation of the processor 120 will be described with reference to FIG. 3.

The app manager module 121 may monitor an application installed in the camera 100. In addition, the app manager module 121 may control the operation of the application. For example, a plurality of applications may be installed in the camera 100. For example, as illustrated in FIG. 3, a first application 111, a second application 112, and a third application 113 may be installed in the camera 100. In addition, the app manager module 121 may monitor the first application 111, the second application 112, and the third application 113, and may control the operations of the first application 111, the second application 112, and the third application 113.

The scheduler setting module 122 may generate or delete a scheduler or change the settings of the scheduler. For example, the scheduler may include information about the operating condition of the application. For example, the scheduler may include information about a time or a day of the week at or on which the application operates. In addition, the scheduler may be mapped to the application. For example, the scheduler may include a scheduler in the form of a calendar.

The scheduler setting module 122 may provide, to the app manager module 121, information about the scheduler that is mapped to the application and includes information about the operation of the application at a preset time.

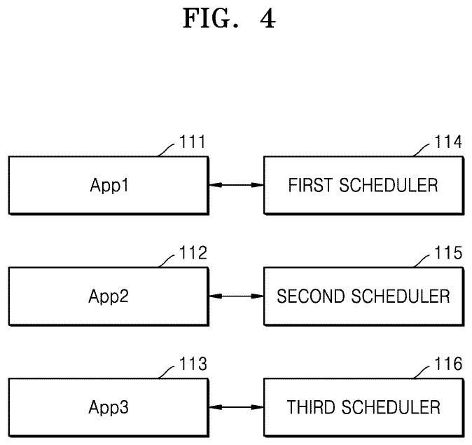

FIG. 4 is a diagram for explaining an application and a scheduler mapped to the application, according to an embodiment of the present disclosure.

Referring to FIGS. 3 and 4, the scheduler setting module 122 according to an embodiment of the present disclosure may provide information about a plurality of schedulers mapped to a plurality of applications to the app manager module 121. For example, as illustrated in FIG. 4, the first scheduler 114 may be mapped to the first application 111. For example, when the first scheduler 114 is set to operate the application from 9:00 to 11:00 every Wednesday, the app manager module 121 may activate the first application 111 mapped to the first scheduler 114 from 9:00 to 11:00 every Wednesday.

For example, as illustrated in FIG. 4, the first application 111, the second application 112, and the third application 113 may be mapped to the first scheduler 114, the second scheduler 115, and the third scheduler 116, respectively.

The scheduler setting module 122 may reset information about the mapping between the application and the scheduler. For example, the scheduler setting module 122 may delete the information about the mapping between the application and the scheduler. In addition, the scheduler setting module 122 may generate the information about the mapping between the application and the scheduler. In addition, the scheduler setting module 122 may change the information about the mapping between the application and the scheduler.

The scheduler setting module 122 may update information about the scheduler including information about the operation of the application based on update information about the setting of the scheduler.

The app manager module 121 may activate or deactivate the application based on information about the operation of the application received from the scheduler setting module 122.

The app manager module 121 may check the scheduler mapped to the application and activate the application only at a preset time based on information about the scheduler mapped to the application.

The app manager module 121 may update information about the scheduler, which is mapped to the application and includes information about the operation of the application at a preset time, according to the update of the scheduler setting module 122.

The camera 100 according to an embodiment of the present disclosure may include an IP camera. For example, the camera 100 according to an embodiment of the present disclosure may include a surveillance camera. In addition, the camera 100 may be equipped with an image analysis application that analyzes images captured by the camera 100. For example, the image analysis application may include an Artificial Intelligence (AI) image analysis application.

The scheduler setting module 122 may generate or delete a scheduler or change the settings of the scheduler based on image analysis results obtained from the image analysis application. For example, the scheduler setting module 122 may map the first application 111, which is an application for daytime surveillance, to the first scheduler 114 having a daytime operation condition based on the image analysis results. In addition, the scheduler setting module 122 may map the second application 112, which is an application for nighttime surveillance, to the second scheduler 115 having a nighttime operation condition based on the image analysis results.

The scheduler setting module 122 may generate or delete a scheduler or change the settings of the scheduler based on the operation priorities of applications equipped in the camera 100. For example, the operation priorities of the applications may be determined by reflecting the usage rate of a Neural Processing Unit (NPU). For example, when the operation priorities of the first application 111, the second application 112, and the third application 113 equipped in the camera 100 are sequentially the second application 112, the first application 111, and the third application 113, the scheduler setting module 122 may map the second application 112, the first application 111, and the third application 113 to each scheduler so that the applications may be executed according to the operation priorities.

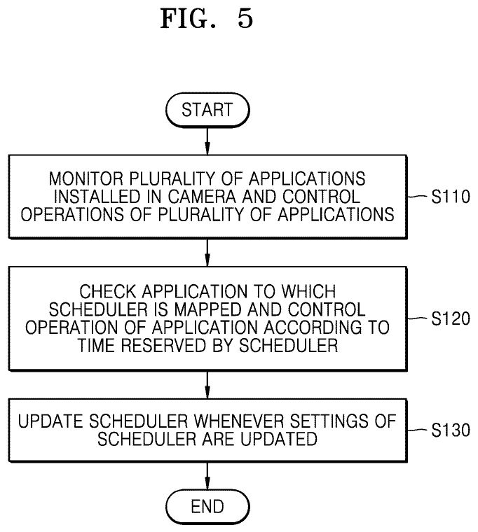

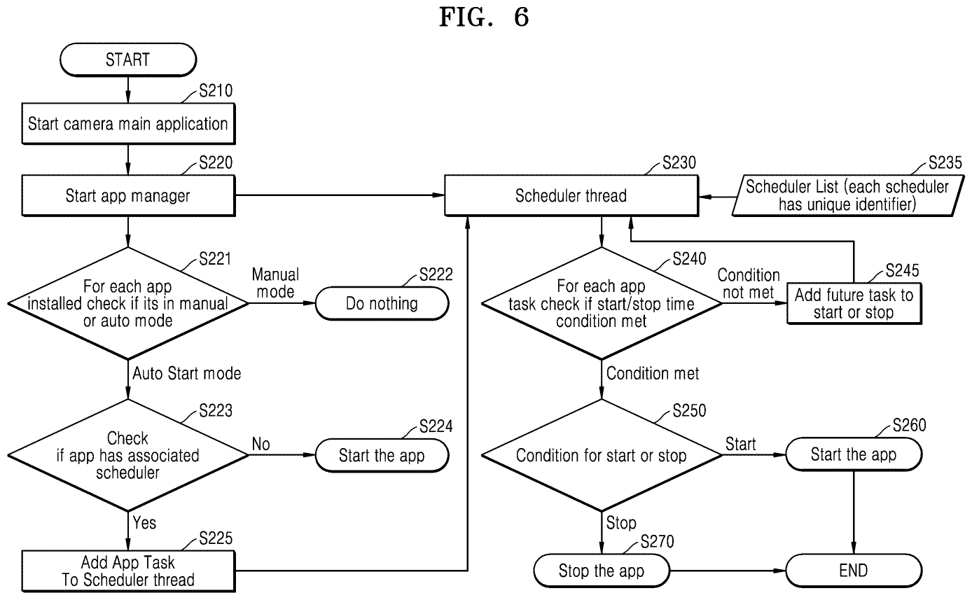

FIGS. 5 and 6 are flowcharts illustrating a method of controlling a camera (hereinafter, referred to as a camera control method), according to an embodiment of the present disclosure.

Referring to FIG. 5, in Operation S110, a processor according to an embodiment of the present disclosure may monitor a plurality of applications installed in a camera and control the operations of the plurality of applications.

In Operation S120, the processor according to an embodiment of the present disclosure may check an application to which a scheduler is mapped and control the operation of the application according to the time reserved by the scheduler.

In Operation S130, the processor according to an embodiment of the present disclosure may update the scheduler whenever the settings of the scheduler are updated.

Referring to FIG. 6, a flowchart illustrating a camera control method according to an embodiment of the present disclosure is shown.

In Operation S210, the processor may execute a main application of the camera. For example, the processor may execute the main application for the main operation of the camera when the camera is turned on.

In Operation S220, the processor may execute an app manager module. For example, the processor may execute the app manager module that controls the operations of a plurality of applications installed in the camera. Following Operation S220, in Operation S230, the processor may execute a scheduler setting module.

In Operation S221, the processor may check whether each application installed in the camera is in a manual mode or an automatic mode. For example, the processor may check whether the execution of the application is in a mode in which the application is manually executed according to a user's command or a mode in which the application is automatically executed without a user's command.

In Operation S222, the processor may not activate the application when the execution of the application is in a manual mode.

Following Operation S221, when the execution of the application is in an automatic mode, in Operation S223, the processor may check whether there is a scheduler mapped to the application.

In Operation S224, the processor may activate the application when there is no scheduler mapped to the application.

In Operations S225 and S230, the processor may execute a scheduler setting module when there is a scheduler mapped to the application.

In Operation S235, the processor may check a scheduler list. For example, each scheduler may include a unique identifier.

In Operation S240, the processor may check whether a start or stop time condition is met for each application based on information about the mapping between the application and the scheduler.

In Operation S245, when the start or stop time condition is not met for the application, the processor may set a future time condition to start or stop the application. That is, the processor may update the information about the mapping between the application and the scheduler.

In Operation S250, when the start or stop time condition is met for the application, the processor may activate (Operation S260) or deactivate (Operation S270) the application according to a start condition or stop condition set in the scheduler.

According to the present disclosure, a user may configure a time to run a certain application by using a general calendar format schedule configuration. A user may install multiple applications on the camera and schedule only a few applications to run at a certain time. Typically, a camera may run only a very small number of applications due to CPU usage issues, and there are restrictions on the use of applications depending on the time. The schedule support of the scheduler according to the present disclosure helps to overcome these restrictions. The app manager may automatically start and stop applications according to the schedule of the scheduler without user intervention. According to the present disclosure, the camera control method may help to effectively utilize camera resources.

A device and/or system described herein may be implemented using hardware components, software components, or a combination thereof. A device and an element described in embodiments may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions. A processing device may run an operating system (OS) and one or more software applications that run on the OS. Also, the processing device may access, store, manipulate, process, and create data in response to execution of software. For easy understanding, one processing device is used, but it will be understood by one of ordinary skill in the art that a processing device may include multiple processing elements and/or multiple types of processing elements. For example, the processing device may include multiple processors or a processor and a controller. In addition, other processing configurations, such as parallel processors, are possible.

Software may include a computer program, a piece of code, an instruction, or a combination thereof, to independently or collectively instruct or configure a processing device to operate as desired. Software and/or data may be embodied permanently or temporarily in any type of machine, component, physical or virtual equipment, computer storage medium or device, or a transmitted signal wave, to provide instructions or data to or to be interpreted by a processing device. Software may also be distributed over network coupled computer systems so that the software is stored and executed in a distributed fashion. Software and data may be stored in one or more computer-readable recording media.

A method according to an embodiment may be embodied as program commands executable by various computer means and may be recorded on a computer-readable medium. The computer-readable medium may include program commands, data files, and data structures separately or in combinations. The program commands recorded on the computer-readable medium may be specially designed and configured for embodiments or may be well-known to and be usable by one of ordinary skill in the art of computer software. Examples of the computer-readable recording medium include a magnetic medium such as a hard disk, a floppy disk, or magnetic tape, an optical medium such as a compact disc read-only memory (CD-ROM) or a digital versatile disc (DVD), a magneto-optical medium such as a floptical disk, and a hardware device specially configured to store and execute program commands such as ROM, random-access memory (RAM), or flash memory. Examples of the program commands include advanced language code that may be executed by a computer by using an interpreter or the like as well as machine language code made by a compiler. The described hardware device may be configured to operate as one or more software modules in order to perform an operation of an embodiment, and the reverse is the same.

Although the embodiments have been described by the limited embodiments and the drawings as described above, various modifications and variations are possible by one of ordinary skill in the art from the above description. For example, appropriate results may be achieved even when the described techniques are performed in a different order from the described method, and/or the described elements such as a system, a structure, an apparatus, and a circuit are combined or integrated in a different manner from the described method or replaced or substituted by other elements or equivalents.

Hence, other implementations, other embodiments, and equivalents of the claims are within the scope of the following claims.

1. A system for controlling a camera, the system comprising:
a processor configured to control an application installed in a camera; and
a memory storing instructions executable by the processor,
wherein the processor comprises:
an app manager module configured to monitor the application and control an operation of the application; and
a scheduler setting module configured to provide, to the app manager module, information about a scheduler that is mapped to the application and includes information about the operation of the application at a preset time.

2. The system of claim 1, wherein the app manager module is further configured to activate or deactivate the application based on the information about the operation of the application received from the scheduler setting module.

3. The system of claim 2, wherein the app manager module is further configured to check a scheduler mapped to the application and activate the application only at a preset time based on information about the scheduler mapped to the application.

4. The system of claim 1, wherein the scheduler setting module is further configured to provide information about a plurality of schedulers mapped to a plurality of applications to the app manager module.

5. The system of claim 4, wherein the scheduler setting module is further configured to reset information about mapping between the application and the scheduler.

6. The system of claim 1, wherein the scheduler setting module is further configured to update the information about the scheduler including the information about the operation of the application based on update information about settings of the scheduler.

7. The system of claim 6, wherein the app manager module is further configured to update the information about the scheduler, which is mapped to the application and includes the information about the operation of the application at a preset time, according to update of the scheduler setting module.

8. A method of controlling a camera by using a processor that controls an application installed in the camera, the method comprising:
monitoring the application; and
controlling an operation of the application based on information about a scheduler that is mapped to the application and includes information about the operation of the application at a preset time.

9. The method of claim 8, wherein the controlling of the operation of the application comprises activating or deactivating the application based on the information about the operation of the application.

10. The method of claim 9, wherein the controlling of the operation of the application comprises:
checking a scheduler mapped to the application; and
activating the application only at a preset time based on information about the scheduler mapped to the application.

11. The method of claim 8, wherein the controlling of the operation of the application comprises controlling the operation of the application based on information about a plurality of schedulers mapped to a plurality of applications.

12. The method of claim 11, wherein the controlling of the operation of the application comprises resetting information about mapping between the application and the scheduler.

13. The method of claim 8, wherein the controlling of the operation of the application comprises updating the information about the scheduler including the information about the operation of the application based on update information about settings of the scheduler.

14. The method of claim 13, wherein the controlling of the operation of the application comprises updating the information about the scheduler that is mapped to the application and includes the information about the operation of the application at a preset time.

15. A computer program stored on a recording medium to execute the method of claim 8 by using a computing device.

16. A computer program stored on a recording medium to execute the method of claim 9 by using a computing device.

17. A computer program stored on a recording medium to execute the method of claim 10 by using a computing device.

18. A computer program stored on a recording medium to execute the method of claim 11 by using a computing device.

19. A computer program stored on a recording medium to execute the method of claim 12 by using a computing device.

20. A computer program stored on a recording medium to execute the method of claim 13 by using a computing device.
